(19) United States
(12) Patent Application Publication
(10) Pub. No.: US 2020/0120416 A1
(43) Pub. Date: Apr. 16, 2020

(54) METHODS AND APPARATUS TO DETECT AN AUDIO SOURCE

(71) Applicant: Intel Corporation, Santa Clara, CA (US)

(72) Inventors: Tongyan Zhai, Portland, OR (US); Shantanu Kulkarni, Hillsboro, OR (US); Devon Worrell, Folsom, CA (US); Srikanth Potluri, Folsom, CA (US)

(21) Appl. No.: 16/715,766

(22) Filed: Dec. 16, 2019

(51) Int. Cl. H04R 1/40; G10L 21/0208

(52) U.S. Cl. CPC H04R 1/406; G10L 21/0208

(57) ABSTRACT

Methods and apparatus to detect an audio source are disclosed. An apparatus for identifying target audio from a computing device, the apparatus comprising a housing including an inner housing, an outer housing, and one or more holes, a bezel area, wherein the bezel area includes one or more digital microphones (DMICs), a display, the display including a display front and a display back, a piezoelectric microphone located between the housing and the display back, the piezoelectric microphone located beneath one of the holes, wherein the piezoelectric microphone is to detect audio, and an audio analyzer to analyze the audio retrieved from the piezoelectric microphone.

### FIELD OF THE DISCLOSURE

This disclosure relates generally to ambient computing and, more particularly, to methods and apparatus to detect an audio source.

### BACKGROUND

In recent years, the role of ambient computing has increased with the advancements made in the field of smart technologies (e.g., smartphones, smart TVs, smart watches, voice-activated digital assistants, motion-controlled appliances, etc.). Ambient computing devices, such as voice and/or speech recognition technologies, operate in the background, without the active participation of the user, and monitor, listen, and respond accordingly.

### BRIEF DESCRIPTION OF THE DRAWINGS

FIG. 1A is a diagram illustrating an example computing device structured according to teachings of this disclosure to detect an audio source.

FIG. 1B is a diagram illustrating an alternate example computing device structured according to teachings of this disclosure to detect an audio source.

FIG. 2 is a diagram illustrating an example computing device structured according to FIG. 1A and includes a locational representation of the example computing device microphone holes.

FIG. 3A is a diagram representing an example cross-sectional view of the example computing devices of FIGS. 1A, 1B, and/or 2.

FIG. 3B is a diagram representative of an alternate cross-sectional view of the example computing devices of FIGS. 1A, 1B, and/or 2.

FIG. 4 is a diagram representative of an example audio triangulation scheme.

FIG. 5 is block diagram of an example audio analyzer of the example computing device of FIGS. 1A, 1B, 2, 3A, and/or 3B.

FIG. 6 is a flowchart representative of machine-readable instructions which may be executed to implement the example audio analyzer of FIG. 5.

FIG. 7 is a block diagram of the example computing device structured to execute the instructions of FIG. 6 to implement the audio analyzer of FIG. 5.

The figures are not to scale. Instead, the thickness of the layers or regions may be enlarged in the drawings. In general, the same reference numbers will be used throughout the drawing(s) and accompanying written description to refer to the same or like parts. As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. Stating that any part is in “contact” with another part means that there is no intermediate part between the two parts. Although the figures show layers and regions with clean lines and boundaries, some or all of these lines and/or boundaries may be idealized. In reality, the boundaries and/or lines may be unobservable, blended, and/or irregular.

Descriptors “first,” “second,” “third,” etc. are used herein when identifying multiple elements or components which may be referred to separately. Unless otherwise specified or understood based on their context of use, such descriptors are not intended to impute any meaning of priority, physical order or arrangement in a list, or ordering in time but are merely used as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

### DETAILED DESCRIPTION

In recent years, the use of voice and/or speech recognition technologies have increased alongside the development of “smart” technologies. The ability to detect and identify particular audio sources and/or signals allows for users to interact with smart technologies without having to actively participate as a typical technology user. Stated differently, voice and/or speech recognition technologies allow users to use a computer without consciously or explicitly “using” a computer in the typical sense (e.g., via a mouse and keyboard).

Detection of a target audio from a computing device, to be used for applications such as voice and/or speech recognition, can be accomplished in a few different manners. Linear microphone arrays can be used for voice recognition but cannot cancel and/or remove background noise that is coming from the opposite direction and is the same distance from the microphones as the target audio source. With this limitation, a third microphone can be used to help triangulate the target audio and remove any background noise, but often increases the bezel area at the edges of computing devices and increases the overall dimensions of computing devices. This increase in size raises the amount of material used and in-turn increases computing device production costs.

One example type of microphone that can be used to detect audio is a piezoelectric microphone. Piezoelectric microphones, also known as contact microphones, sense audio vibrations through contact with solid objects. An electrical charge (e.g., voltage) is produced by the piezoelectric microphone in response to a mechanical stress produced by vibrations and/or audio signals. The electric charge produced can be converted and digitized into a digital signal that can be used alongside other audio and/or digital signals.

Examples disclosed herein include an example audio analyzer to detect an audio source, using audio received through an array of microphones. In some examples, at least one piezoelectric, thin film microphone, herein referred to as a piezo microphone, is used in conjunction with digital microphones (DMIC) included in the array of microphones to detect an audio source and/or audio signal(s). In such examples, at least three microphones (e.g., piezo microphones or DMICs) are used to create the array of microphones. In examples disclosed herein, the locations of the microphones in the array are non-collinear. In such examples, the DMIC(s) are located in an example bezel of the computing device.

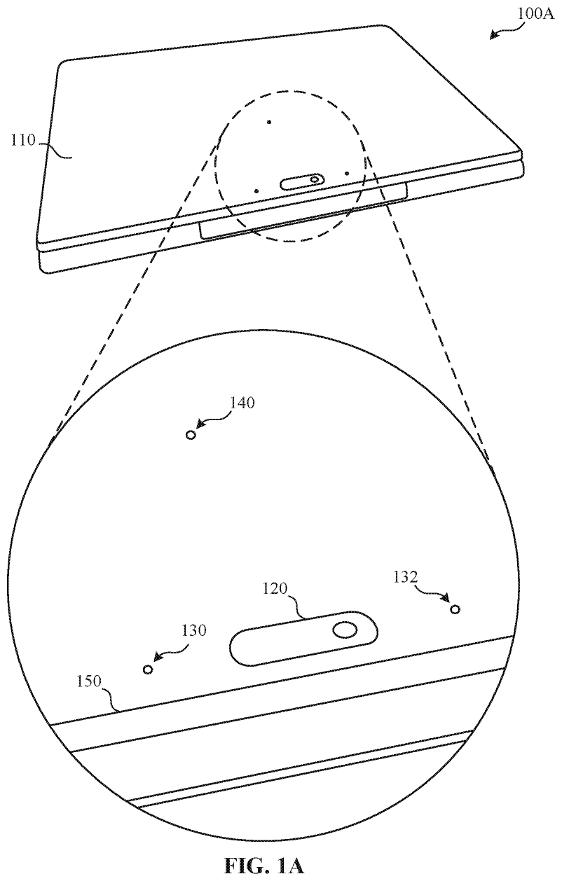

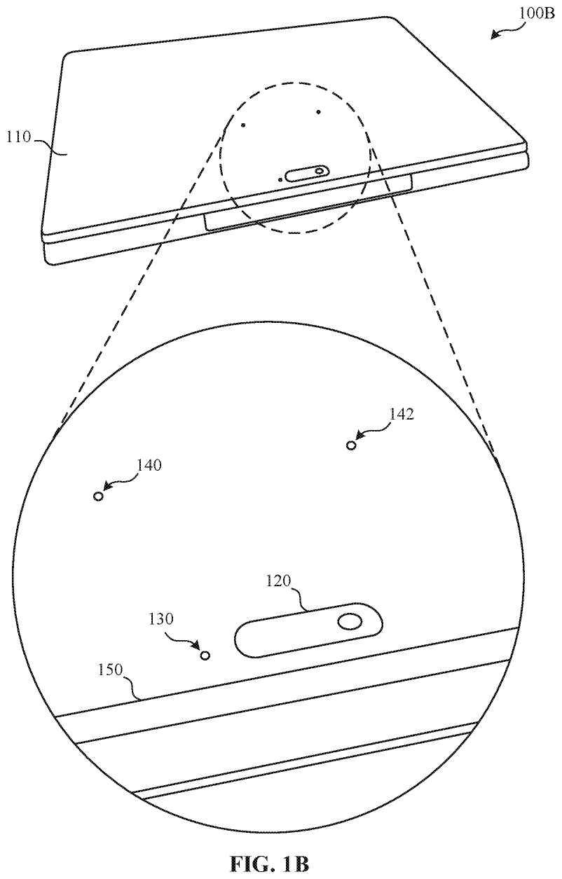

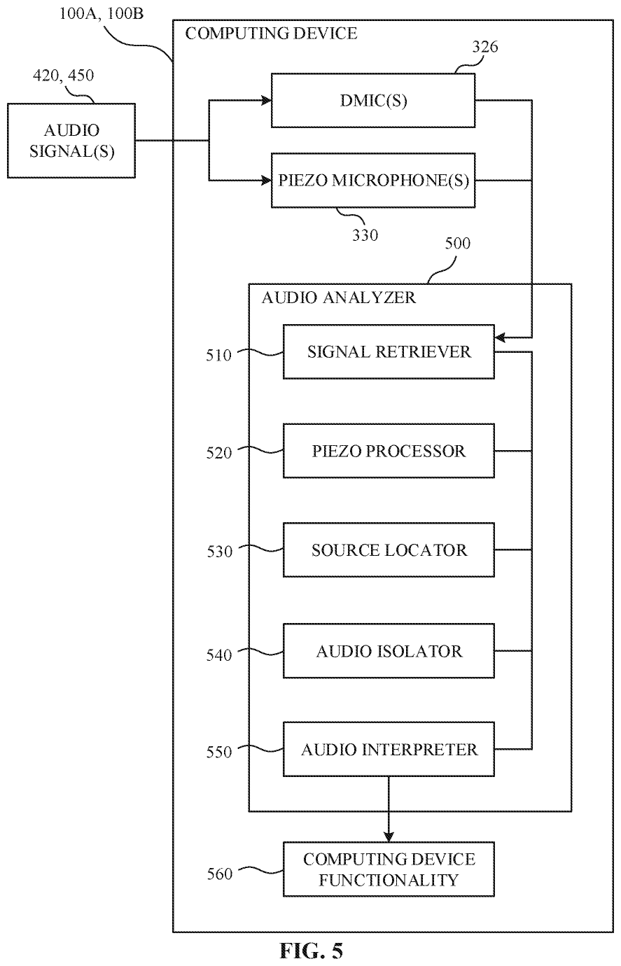

In the illustrated example of FIG. 1A, an example computing device 100A includes an example housing 110, an example camera 120, a first example DMIC hole 130, a second example DMIC hole 132, and a first example piezo hole 140. The computing device 100A also includes an example audio analyzer 500 to analyze the signals received by the microphones and is contained within the computing device 100A. Additional detail in connection with the audio analyzer 500 is described in reference to FIG. 5. In the illustrated examples of FIG. 1A and 1B, the computing devices 100A, 100B are shown as laptop form factors, but other form factors could alternatively be used, such as, for example, a mobile device, a tablet, a personal assistant (e.g., Amazon Echo Device), a smart home device (e.g., thermostats, lights, kitchen appliances, etc.), etc.

In the illustrated example of FIG. 1A, the computing device 100A includes the housing 110 to provide structure and protection to the inner components of the computing device 100A. For example, the housing 110 encases an example display and forms a portion of an example bezel area 324. The housing 110 also includes various holes (e.g., the first DMIC hole, the second DMIC hole, and/or the first piezo hole) for audio detection purposes.

In the illustrated example of FIG. 1A, the computing device 100A includes an example camera 120. The example camera of FIG. 1A can capture images and/or videos and is located in the bezel area 324 of the computing device 100A. In the illustrated example of FIG. 1A, the camera 120 is shown between the first and second DMIC holes 130, 132. However, in some examples, the camera 120 may be in a different bezel location and/or not included in the computing device 100A.

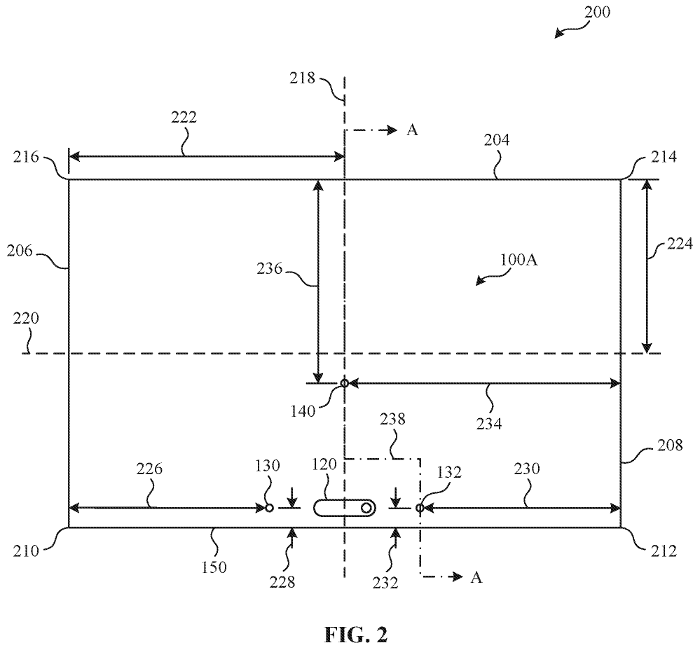

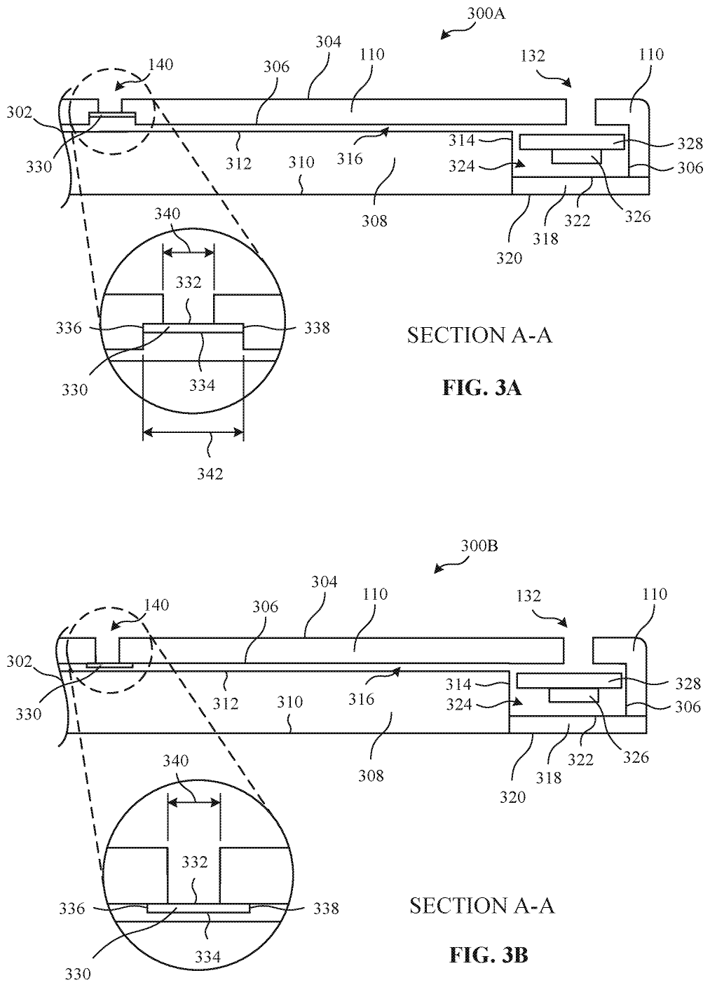

In the illustrated example of FIG. 1A, the computing device 100A includes an example microphone hole array. The example microphone hole array of FIG. 1A includes the first DMIC hole 130, the second DMIC hole 132, and the first piezo hole 140. The first and second DMIC holes 130, 132 are located near a first edge 150 of the computing device 100A, further described in connection with FIG. 2. The first DMIC hole 130, the second DMIC hole 132, and the first piezo hole 140 are positioned in a non-collinear and/or triangular (e.g., equilateral triangle, isosceles triangle, or scalene triangle) array. Additional locational references and cross-sectional views of the first and second DMIC holes 130, 132 and the piezo hole 140 are shown in FIGS. 2, 3A, and 3B.

In the illustrated example of FIG. 1B, an example computing device 100B includes the housing 110, the camera 120, the first DMIC hole 130, the first piezo hole 140, and a second example piezo hole 142. In the illustrated example of FIG. 1B, the example computing device 100A of FIG. 1A is implemented with a different example microphone hole array configuration. As shown in FIG. 1B, one DMIC hole 130 and two piezo holes 140, 142 are used.

FIGS. 1A and 1B illustrate two example microphone hole arrays, but the example computing devices 100A, 100B may additionally and/or alternatively include other microphone hole array configurations. For example, the computing devices 100A, 100B can include any number of DMIC holes 130, 132 and/or piezo holes 140, 142. In such examples, the computing devices 100A, 100B can include any number of DMICs 326 and piezo microphones 330 of FIGS. 3A and 3B, where at least one of the microphones is a piezo microphone 330. In such examples, the microphone hole arrays are arranged in a non-collinear and/or triangular array, and the piezo microphones 330 are coupled to the computing device 100A, 100B near the piezo hole(s) 140, 142.

In the illustrated example of FIG. 2, an example diagram 200, including locational and/or otherwise dimensional references, is shown. For example, the diagram 200 represents the computing device 100A of FIG. 1A and includes the first edge 150, a second example edge 204, a third example edge 206, and a fourth example edge 208, the first edge 150 is opposite the second edge 204, and the third edge 206 being opposite the fourth edge 208. In such examples, the first edge 150 and the third edge 204 form a first example corner 210. In such examples, the first edge 150 and the fourth edge 208 form a second example corner 212. In such examples, the second edge 204 and the fourth edge 208 form a third example corner 214. In such examples, the second edge 204 and the third edge 206 form a fourth example corner 216. In FIG. 2, the corners 210, 212, 214, 216 are shown as vertices, but alternatively may be any other type of edge intersection (e.g., round, chamfer, etc.).

In the illustrated example of FIG. 2, the diagram 200 includes an example latitude line 218 and an example longitude line 220. For example, the latitude line 218 is a reference line used for locational and/or dimensional purposes and is parallel to the third and fourth edges 206, 208. In such examples, the latitude line 218 is a first example distance 222 from the third edge 206. In such examples, the first distance 222 is equivalent to half of the length of the first edge 150 or the second edge 204, but alternatively may be any other distance to centrally locate the latitude line 218. For example, the longitude line 220 is a reference line used for locational and/or dimensional purposes and is parallel to the first edge 150 and the second edge 204. In such examples, the longitude line 220 is a second distance 224 from the second edge 204. In such examples, the second distance 224 is equivalent to half of the length of the third edge 206 or the fourth edge 208, but alternatively may be any other distance to centrally locate the longitude line 220.

In the illustrated example of FIG. 2, the diagram 200 includes the camera 120, the first DMIC hole 130, the second DMIC hole 132, and the first piezo hole 140. In examples disclosed herein, the first DMIC hole 130, the second DMIC hole 132, and the first piezo hole 140 are located (e.g., measured, referenced, etc.) from the center of each hole, wherein each hole contains a centerline. In such examples, the DMIC(s) 326 and/or the piezo microphone(s) 330 are perpendicularly located a particular distance from the centerlines of each hole. For example, the first DMIC hole 130 is a third example distance 226 from the third edge 206 and is a fourth example distance 228 from the first edge 150. For example, the second DMIC hole 132 is a fifth example distance 230 from the fourth edge 208 and is a sixth example distance 232 from the first edge 150. For example, the first piezo hole 140 is a seventh example distance 234 from the fourth edge 208 and is an eighth example distance 236 from the second edge 204. In such examples, the third distance 226, the fifth distance 230, and the seventh distance 234 are measured parallel to the longitude line 220. In such examples, the fourth distance 228, the sixth distance 232, and the eighth distance 236 are measured parallel to the latitude line 218.

In some examples, the third distance 226 and the fifth distance 230 are equivalent. Alternatively, the third distance 226 and the fifth distance 230 can be different values. In such examples, the sum of the third distance 226 and the fifth distance 230 is less than the length of the first edge 150 or the second edge 204. In some examples, the fourth distance 228 and the sixth distance 232 are equivalent. Alternatively, the fourth distance 228 and the sixth distance 232 can be different values. In some examples, the fourth distance 228 and the sixth distance 232 are values that place the centers of the DMIC holes 130, 132 within the bezel area 324 of FIGS. 3A and 3B.

In some examples, the seventh distance 234 is equivalent to the first distance 222 and/or otherwise locates the first piezo hole 140 on the latitude line 218. In some examples, the seventh distance 234 is any distance that is less than the length of the first edge 150 or the second edge 204 and is greater than zero. In some examples, the eighth distance 236 is equivalent to the second distance 224 and/or otherwise locates the first piezo hole 140 on the longitude line 220. In some examples, the eighth distance 236 is any distance that is greater than zero and does not locate the first piezo hole 140 in the bezel area 324.

In the illustrated example of FIG. 2, the diagram 200 includes an example section line 238. For example, the section line 238 intersects (e.g., perpendicularly intersects) the first edge 150 and the second edge 204. In such examples, the section line 238 intersects the centers of the second DMIC hole 132 and the first piezo hole 140. The section line 238 is used to indicate the cross-sectional views of FIGS. 3A and 3B and is referenced as section A-A.

In the illustrated example of FIGS. 3A and 3B, an example cross-sectional view 300A and an alternate cross-sectional view 300B illustrate cross-sectional views of the example computing device 100A of FIG. 2. For example, the computing device 100A includes the housing 110, the second DMIC hole 132, the first piezo hole 140, an example display 308, an example bezel cover 318, the bezel area 324, the DMIC 326, an example printed circuit board (PCB) 328, and the piezo microphone 330. In FIG. 3A and 3B, an example break line 302 is used to cut off a portion of the cross-sectional view 300A, 300B.

In some examples, the housing 110 further includes an example outer housing 304 and an example inner housing 306. For example, the housing 110 includes the second DMIC hole 132 and the first piezo hole 140. In such examples, the second DMIC hole 132 and the first piezo hole 140 are through-holes (e.g., thru-hole) that go through the inner housing 304 plane and the outer housing 306 plane.

In some examples, the display 308 further includes an example display front 310, an example display back 312, and an example display top 314. For example, the display 308 is often seen and/or interacted with by a user during typical operation of the computing device 100A. In such examples, the display front 310 is viewed by the user during operation of the computing device 100A. In some examples, there is an example gap 316 between the inner housing 306 and the display back 312. In some examples, the inner housing 306 is flush with the display back 312 and the gap 316 does not exist.

In some examples, the bezel cover 318 further includes an example outer bezel 320 and an example inner bezel 322. For example, the inner housing 306, the display top 314, and the inner bezel 322 form the boundaries for the bezel area 324. In such examples, the bezel cover 318 protects the components within the bezel area 324. In such examples, the bezel area 324 includes the DMIC 326 and the PCB 328 to detect and transmit audio signals to an example audio analyzer 500 further described in connection to FIG. 5. For example, the PCB 328 provides mechanical support for the DMIC 326 and electronically connects the DMIC 326 to additional electrical components within the computing device 100A. The PCB 328 can be single sided, double sided, and/or multi-layered to provide electrical connectivity using conductive tracks, pads and/or other features etched from one or more sheet layers of a conductive material, and/or via any other manufacturing technique.

In some examples, the DMIC 326 of FIG. 3A and/or 3B is coupled (e.g., mechanically coupled and electrically coupled) to the PCB 328 and is a digital microphone array used to extract target audio from ambient noise. In such examples, the PCB 328 is coupled (e.g., mechanically coupled and/or electrically coupled) (e.g., electrical scaffolding, circuit boards, etc.) to the bezel area 324 boundaries. In some examples, the DMIC 326 is implemented using one or more directional microphones, omnidirectional microphones, and/or a combination of both. In some implementations, the DMIC 326 and the PCB 328 can be combined into one singular component. Typically, the DMIC 326 is as small as possible, but can be any size allowing it to fit within the boundaries of the bezel area 324 of the computing device 100A.

The piezo microphone 330 is a thin film, piezoelectric microphone that is used to detect audio signals (e.g., audio vibrations), but alternatively may be any other type of piezoelectric microphone. In some examples, the piezo microphone 330 further includes a first example side 332, a second example side 334, a third example side 336, and a fourth example side 338, the first and second sides 332, 334 being opposite each other, the third and fourth sides 336, 338 being opposite each other. In some examples, the housing 110 further includes a recess 342 (e.g., a counterbore). In such examples, the recess 342 is greater than the example first piezo hole diameter 340 and is typically based on the size of the piezo microphone 330 used in the computing device 100A.

In some examples, the piezo microphone 330 is coupled (e.g., fastened, glued, press-fit, etc.) to the inside of the recess 342. In such examples, the first side 332 is positioned toward the first piezo hole 140, and the third and fourth sides 336, 338 are flush with the recess 342. In other examples, the first side 332 is positioned toward the first piezo hole 140, and the third and fourth sides 336, 338 are not in contact with the recess 342. In some examples, the second side 334 is positioned toward the first piezo hole 140, and the third and fourth sides 336, 338 are flush with the recess 342. In other examples, the second side 334 is positioned toward the first piezo hole 140, and the third and fourth sides 336, 338 are not in contact with the recess 342.

In examples in which there is no gap 316, the piezo microphone 330 is coupled (e.g., fastened, glued, etc.) to the display back 312. In such examples, the first and/or second sides 332, 334 can be flush with the display back 312 with the third and fourth sides 336, 338 either flush or not in contact with the recess 342.

In FIG. 3B, the housing does not include the recess 342 and the piezo microphone 330 may be positioned within the gap 316. In some examples, the first side 332 is positioned toward the first piezo hole 140 and is coupled (e.g., fastened, glued, etc.) to the inner housing 306. In some examples, the second side 334 is positioned toward the first piezo hole 140 and is coupled (e.g., fastened, glued, etc.) to the inner housing 306. In such examples, the piezo microphone 330 is not coupled to the display back 312, but alternatively may be coupled to the display back 312.

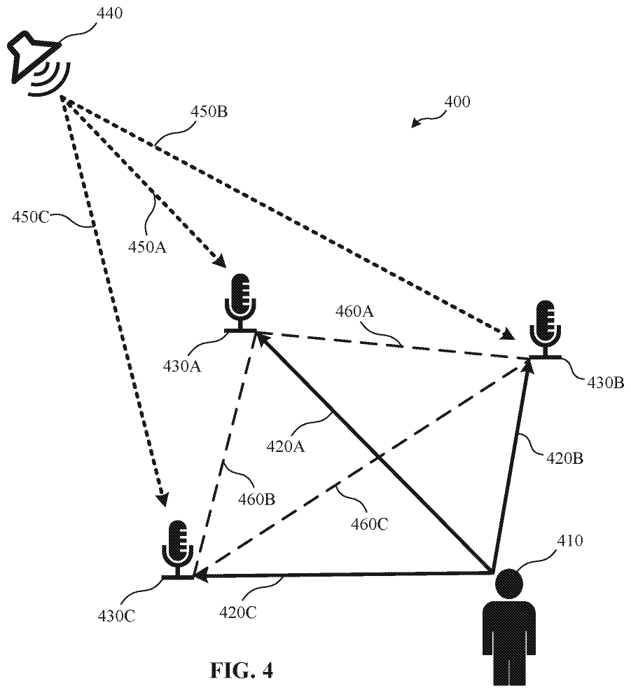

In the illustrated example of FIG. 4, an example audio triangulation scheme 400 illustrates how the microphones 326, 330 of FIGS. 3A, and 3B can triangulate different audio signals to locate the source of the audio. In FIG. 4, the audio triangulation scheme 400 includes an example target audio source 410, example target audio signals 420A, 420B, 420C, example microphones 430A, 430B, 430C, an example ambient audio source 440, example ambient audio signals 450A, 450B, 450C, and example microphone distances 460A, 460B, 460C.

In the illustrated example of FIG. 4, the audio triangulation scheme 400 includes the target audio source 410 that produces the target audio signals 420A, 420B, 420C. For example, the target audio source 410 of FIG. 4 is a person but may additionally and/or alternatively be any audio signal producing element. The target audio signals 420A, 420B, 420C are audio signals produced by the target audio source 410 and are audio signals meant to be interpreted by the audio analyzer 500 further described in connection with FIG. 5.

In the illustrated example of FIG. 4, the audio triangulation scheme 400 includes the microphones 430A, 430B, 430C to detect and transmit audio signals. For example, the microphones 430A, 430B, 430C are representative of the DMICs 326 and piezo microphone 330 of FIGS. 3A and 3B, but for the purpose of the illustrated audio triangulation scheme 400, the microphones 430A, 430B, 430C are shown as general microphones.

In the illustrated example of FIG. 4, the audio triangulation scheme 400 includes the ambient audio source 440 that produces the ambient audio signals 450A, 450B, 450C. For example, the ambient audio source 440 of FIG. 4 is representative of any audio signal producing element that is not meant to be interpreted (e.g., TV, radio, mechanical noise, etc.).

The microphones 430A, 430B, 430C detect the target audio signals 420A, 420B, 420C and the ambient audio signals 450A, 450B, 450C and determine what audio source the signals originated from. In some examples, there may be more than one ambient audio source 440, but for simplicity purposes, only one ambient audio source is shown in FIG. 4. In some examples, more than three microphones 430A, 430B, 430C can be used, but for simplicity and continuity purposes, only three microphones 430A, 430B, 430C are shown in FIG. 4.

In some examples, the microphones 430A, 430B, 430C detect the same audio at different times and, by determining the time difference between when the microphones 430A, 430B, 430C received the audio, and knowing the distances 460A, 460B, 460C between the microphones 430A, 430B, 430C, the location of the audio source can be triangulated. In some examples, in response to the target audio source 410 being located, the audio analyzer 500, described in connection with FIG. 5, can then remove (e.g., filter) the audio being received from the opposite direction of the target audio source 410. In FIG. 4, all and/or portions of the ambient audio signals 450A, 450B, 450C can be removed from the audio interpretation process to increase the interpretation of the target audio.

In the illustrated example of FIG. 5, the diagram includes the audio signals 420, 450, the DMIC(s) 326, the piezo microphone(s) 330, the audio analyzer 500, and an example computing device functionality 560. In FIG. 5, the diagram illustrates the interactions between the audio signal(s) 420, 450 and the computing device 100A, 100B components (e.g., the DMIC(s) 326, the piezo microphone(s) 330, the audio analyzer 500, and the computing device functionality 560).

In the illustrated example of FIG. 5, the example audio analyzer 500 interprets audio signals received by the DMIC(s) 326 and/or piezo microphone(s) 330 of FIGS. 3A and 3B. For example, in FIG. 5, the audio signal(s) 420A, 420B, 420C, 450A, 450B, 450C of FIG. 4 are detected by the DMIC(s) 326 and the piezo microphone(s) 330. In such examples, the DMIC(s) 326 converts the audio signal(s) into digital signal(s) and the piezo microphone(s) 330 converts the audio signal(s) into voltage signal(s). The DMIC(s) 326 and the piezo microphone(s) 330 then transmit the digital and/or voltage signals to the audio analyzer 500.

As previously mentioned in connection with FIGS. 3A and 3B, the DMIC(s) 326 can be implemented by directional microphones, omnidirectional microphones, and/or a combination thereof. In some implementations, the DMIC 326 and the PCB 328 of FIGS. 3A and 3B can be combined into one singular component. The piezo microphone(s) 330 can be implemented by a thin film, piezoelectric microphone, but alternatively may be any other type of microphone.

The audio analyzer 500 of FIG. 5 includes an example signal retriever 510, an example piezo processor 520, an example source locator 530, an example audio isolator 540, and an example audio interpreter 550. The audio analyzer 500 of FIG. 5 is coupled (e.g., electrically coupled) to the DMIC(s) 326 and piezo microphone(s) 330 of FIGS. 3A and 3B.

The signal retriever 510 retrieves signals (e.g., voltage signals and digital signals,) transmitted by the DMIC(s) 326 and/or the piezo microphone(s) 330. For example, the piezo microphone(s) 330 transmit piezoelectric voltage signals corresponding to an audio signal, based on the properties of the piezo microphone(s) 330.

The piezo processor 520 converts the voltage signal, output by the piezo microphone 330, into a digital signal that can be compared with the digital signals transmitted by the DMIC(s) 326. In some examples, the piezo processor 520 can convert more than one voltage reading into a digital signal. In some examples, because the voltage signal produced by the piezo microphone 330 is often small, the voltage signal is amplified by the piezo processor 520 before the voltage signal is converted to a digital signal.

The source locator 530 identifies a location of the target audio source 410. In such examples, the source locator 530 identifies the target audio signals 420A, 420B, 420C coming from the target audio source 410 and analyzes differences in time(s) of receipt of the target audio signals 420A, 420B, 420C. For instance, each microphone 326, 330 can detect and/or receive the same audio signal at different times. The difference between each microphone 326, 330 detection time is referred to as the difference in time of receipt. In such examples, the source locator 530 uses the microphone distances 460A, 460B, 460C, the speed of sound, and the differences in time of receipt of the target audio signals 420A, 420B, 420C to triangulate and/or otherwise determine the target audio source 410 location.

The audio isolator 540 removes the ambient audio signals 450A, 450B, 450C coming from the opposite direction of the target audio source 410. For example, the audio isolator 540 uses the target audio source 410 location to identify and remove the ambient audio signals 450A, 450B, 450C. In such examples, the ambient audio signals 450A, 450B, 450C can be removed in entirety and/or in portions depending on the location of the ambient audio source 440.

The audio interpreter 550 interprets (e.g., reads, analyzes, translates) the target audio signals 420A, 420B, 420C and transmits the results to the computing device functionality 560. In some examples, the audio interpreter 550 may interpret ambient audio signals 450A, 450B, 450C alongside the target audio signals 420A, 420B, 420C that were not removed, wherein the ambient audio signals 450A, 450B, 450C are sometimes seen as noise within the target audio signals 420A, 420B, 420C.

The computing device functionality 560 of FIG. 5 can be any operation performed by the computing device 100A, 100B. For example, the results transmitted from the audio interpreter 550 can invoke the computing device functionality 560 to perform operations such as, for example, playing a song, turning on a light, adding an item to a list, conducting a webpage search, etc. In some examples, the computing device functionality 560 can perform more than one operation based on the results transmitted by the audio interpreter 550.

The example signal retriever 510, the example piezo processor 520, the example source locator 530, the example audio isolator 540, and/or the example audio interrupter 550 may be implemented by a logic circuit, such as a hardware processor. However, any other type of circuitry additionally or alternatively be used such as, for example, one or more analog or digital circuit(s), logic circuits, programmable processor(s), ASIC(s), PLD(s), FPLD(s), programmable controller(s), GPU(s), DSP(s), etc.

While an example manner of implementing the audio analyzer 500 is illustrated in FIG. 5, one or more of the elements, processes and/or devices illustrated in FIG. 5 may be combined, divided, re-arranged, omitted, eliminated and/or implemented in any other way. Further, the example signal retriever 510, the example piezo processor 520, the example source locator 530, the example audio isolator 540, the example audio interpreter 550, and/or, more generally, the example audio analyzer 500 of FIG. 5 may be implemented by hardware, software, firmware and/or any combination of hardware, software and/or firmware. Thus, for example, any of the example signal retriever 510, the example piezo processor 520, the example source locator 530, the example audio isolator 540, the example audio interpreter 550, and/or, more generally, the example audio analyzer 500 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example signal retriever 510, the example piezo processor 520, the example source locator 530, the example audio isolator 540, and/or the example audio interpreter 550 is/are hereby expressly defined to include a non-transitory computer readable storage device or storage disk such as a memory, a digital versatile disk (DVD), a compact disk (CD), a Blu-ray disk, etc. including the software and/or firmware. Further still, the example audio analyzer 500 may include one or more elements, processes and/or devices in addition to, or instead of, those illustrated in FIG. 5, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

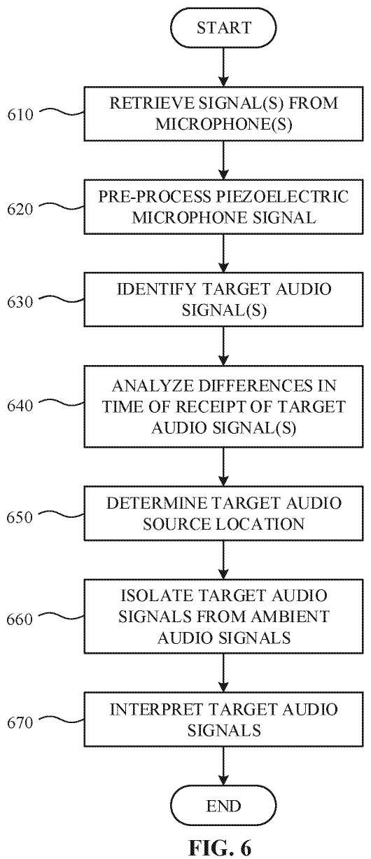

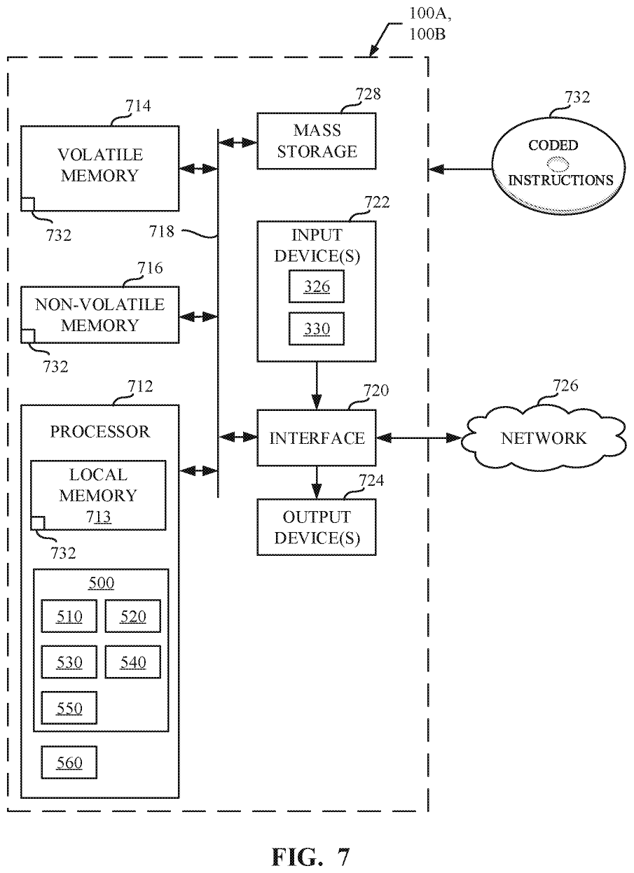

A flowchart representative of example hardware logic, machine-readable instructions, hardware implemented state machines, and/or any combination thereof for implementing the audio analyzer 500 is shown in FIG. 6. The machine-readable instructions may be one or more executable programs or portion(s) of an executable program for execution by a computer processor such as the processor 712 shown in the example processor platform 700 discussed below in connection with FIG. 7. The program may be embodied in software stored on a non-transitory computer readable storage medium such as a CD-ROM, a floppy disk, a hard drive, a DVD, a Blu-ray disk, or a memory associated with the processor 712, but the entire program and/or parts thereof could alternatively be executed by a device other than the processor 712 and/or embodied in firmware or dedicated hardware. Further, although the example program is described with reference to the flowchart illustrated in FIG. 6, many other methods of implementing the example audio analyzer 500 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, a field programmable gate array (FPGA), an ASIC, a comparator, an operational-amplifier (op-amp), a logic circuit, etc.) structured to perform the corresponding operation without executing software or firmware.

The machine-readable instructions described herein may be stored in one or more of a compressed format, an encrypted format, a fragmented format, a compiled format, an executable format, a packaged format, etc. Machine readable instructions as described herein may be stored as data (e.g., portions of instructions, code, representations of code, etc.) that may be utilized to create, manufacture, and/or produce machine executable instructions. For example, the machine-readable instructions may be fragmented and stored on one or more storage devices and/or computing devices (e.g., servers). The machine-readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine-readable instructions may be stored in multiple parts, which are individually compressed, encrypted, and stored on separate computing devices, wherein the parts when decrypted, decompressed, and combined form a set of executable instructions that implement a program such as that described herein.

In another example, the machine-readable instructions may be stored in a state in which they may be read by a computer, but require addition of a library (e.g., a dynamic link library (DLL)), a software development kit (SDK), an application programming interface (API), etc. in order to execute the instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, the disclosed machine-readable instructions and/or corresponding program(s) are intended to encompass such machine-readable instructions and/or program(s) regardless of the particular format or state of the machine-readable instructions and/or program(s) when stored or otherwise at rest or in transit.

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example processes of FIG. 6 may be implemented using executable instructions (e.g., computer and/or machine-readable instructions) stored on a non-transitory computer and/or machine-readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

FIG. 6 is a flowchart representative of example machine-readable instructions that may be executed to implement the audio analyzer 500 of FIG. 5. The example machine-readable instructions of FIG. 6 begin at block 610 at which the signal retriever 510 retrieves signals (e.g., voltage signals and digital signals,) from the DMIC(s) 326 and/or piezo microphone(s) 330 of FIGS. 3A and 3B. In some examples, the signal retriever 510 can retrieve audio signals from one or more microphones (e.g., DMIC(s) 326, piezo microphones 330, etc.).

The piezo processor 520 converts the voltage signal, produced by the piezo microphone 330, into a digital signal that can be compared to the digital signal(s) transmitted by the DMIC(s) 326. (Block 620). In some examples, the piezo processor 520 amplifies the voltage signal before converting the voltage signal to a digital signal.

The source locator 530 identifies the target audio source 410 from the digital signals converted by the DMIC(s) 326 and/or the piezo processor 520. (Block 630). For example, the source locater 530 identifies the target audio signals 420A, 420B, 420C based on particular parameters (e.g., frequency, amplitude, phase, etc.) within each signal. In such examples, based on the parameters of the audio signals detected by the DMIC(s) 326 and/or piezo microphones 330, the source locator 530 can determine whether a detected audio signal is a target audio signal 420A, 420B, 420C or not.

For example, once the target audio signals 420A, 420B, 420C are identified, the source locator 530 analyzes differences in time of receipt of the target audio signal(s) 420A, 420B, 420C. (Block 640). For example, because the distances between the DMIC(s) 326 and piezo microphone(s) 330 are known, along with the speed of sound, the difference in target audio signal 420A, 420B, 420C time of receipt can be used to triangulate and/or otherwise determine the target audio source 410 location. (Block 650). In some examples, the source locator 530 uses three or more target audio signals 420A, 420B, 420C to triangulate the target audio source 410 location. However, any number of audio signals may additionally or alternatively be used to determine the location of the target audio source 410. The number of audio signals used may be based on, for example, the number of DMIC(s) 326 and/or piezo microphone(s) 330 implemented in the computing device 100A, 100B. Such an approach enables different combinations of audio receiving devices (e.g., microphones) to be used based on operational conditions of the computing device 100A, 100B (e.g., whether a computing device lid is opened or closed, other computing device microphones are available).

The audio isolator 540 isolates the target audio signal(s) 420A, 420B, 420C from the ambient audio signals 450A, 450B, 450C. (Block 660). For example, the audio isolator 540, removes at least a portion of the ambient audio signal(s) 450A, 450B, 450C. In such examples, the audio isolator 540 removes the ambient audio signal(s) 450A, 450B, 450C to reduce the number of audio signals being interpreted by the audio analyzer 500 and allow for improved interpretation of the target audio signals 420A, 420B, 420C.

The audio interpreter 550 interprets (e.g., reads, analyzes, translates) the target audio signals 420A, 420B, 420C. (Block 670). For example, the audio interpreter 550 interprets the target audio signals 420A, 420B, 420C and transmits the results to the computing device functionality 560 to enable the computing device functionality 560 to perform an action based on the results (e.g., play a song, turn on a light, add an item to a list, conduct a webpage search, etc.). In some examples, the audio interpreter 550 interprets the target audio signals 420A, 420B, 420C and any ambient audio signals 450A, 450B, 450C that were not removed by the audio isolator 440.

The example instructions of FIG. 6 are executed continuously while audio, above a particular volume, is being detected by the DMIC(s) 326 and/or the piezo microphone(s) 330. In such examples, the DMIC(s) 326 and piezo microphone(s) 330 are powered by the computing device 100A, 100B and can be turned on and/or off under particular conditions and/or user commands. In some examples, the instructions of FIG. 6 can be initialized when the microphones 326, 330 are powered and audio of a particular volume is detected by the microphones 326, 330.

FIG. 7 is a block diagram of the example computing device 100A, 100B structured to execute the instructions of FIG. 6 to implement the audio analyzer 500 of FIG. 5. The computing device 100A, 100B can be, for example, a server, a personal computer, a workstation, a self-learning machine (e.g., a neural network), a mobile device (e.g., a cell phone, a smart phone, a tablet such as an iPad), a personal digital assistant (PDA), an Internet appliance, a DVD player, a CD player, a digital video recorder, a Blu-ray player, a gaming console, a personal video recorder, a set top box, a headset or other wearable device, or any other type of computing device.

The computing device 100A, 100B of the illustrated example includes a processor 712. The processor 712 of the illustrated example is hardware. For example, the processor 712 can be implemented by one or more integrated circuits, logic circuits, microprocessors, GPUs, DSPs, or controllers from any desired family or manufacturer. The hardware processor may be a semiconductor based (e.g., silicon based) device. In this example, the processor implements the example signal retriever 510, the example piezo processor 520, the example source locator 530, the example audio isolator 540, the example audio interpreter 550, and the example computing device functionality 560. In some examples, the audio analyzer 500 and/or the computing device functionality 560 of FIG. 7 can be implemented separately from the processor 712.

The processor 712 of the illustrated example includes a local memory 713 (e.g., a cache). The processor 712 of the illustrated example is in communication with a main memory including a volatile memory 714 and a non-volatile memory 716 via a bus 718. The volatile memory 714 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 716 may be implemented by flash memory and/or any other desired type of memory device. Access to the main memory 714, 716 is controlled by a memory controller.

The computing device 100A, 100B of the illustrated example also includes an interface circuit 720. The interface circuit 720 may be implemented by any type of interface standard, such as an Ethernet interface, a universal serial bus (USB), a Bluetooth® interface, a near field communication (NFC) interface, and/or a PCI express interface.

In the illustrated example, one or more input devices 722 are connected to the interface circuit 720. The input device(s) 722 permit(s) a user to enter data and/or commands into the processor 712. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 724 are also connected to the interface circuit 720 of the illustrated example. The output devices 724 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 720 of the illustrated example, thus, typically includes a graphics driver card, a graphics driver chip and/or a graphics driver processor.

The interface circuit 720 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 726. The communication can be via, for example, an Ethernet connection, a digital subscriber line (DSL) connection, a telephone line connection, a coaxial cable system, a satellite system, a line-of-site wireless system, a cellular telephone system, etc.

The computing device 100A, 100B of the illustrated example also includes one or more mass storage devices 728 for storing software and/or data. Examples of such mass storage devices 728 include floppy disk drives, hard drive disks, compact disk drives, Blu-ray disk drives, redundant array of independent disks (RAID) systems, and digital versatile disk (DVD) drives.

The machine executable instructions 732 of FIG. 7 may be stored in the mass storage device 728, in the volatile memory 714, in the non-volatile memory 716, and/or on a removable non-transitory computer readable storage medium such as a CD or DVD.

From the foregoing, it will be appreciated that example methods and apparatus have been disclosed that detect an audio source. The disclosed methods and apparatus improve the efficiency of using a computing device by more easily (e.g., less computation) identifying target audio without increasing the physical dimensions of the computing device. The disclosed methods, systems, articles of manufacture, and apparatus are accordingly directed to one or more improvement(s) in the functioning of a computer.

Further examples and combinations thereof include the following:

Example 1 includes an apparatus for identifying target audio from a computing device, the apparatus comprising a housing including an inner housing, an outer housing, and one or more holes, a bezel area, wherein the bezel area includes one or more microphones, a display, the display including a display front and a display back, a piezoelectric microphone located between the housing and the display back, the piezoelectric microphone located beneath one of the holes, wherein the piezoelectric microphone is to detect audio, and an audio analyzer to analyze the audio retrieved from the piezoelectric microphone.

Example 2 includes the apparatus of example 1, wherein the computing device is a laptop, the laptop to identify target audio while in a closed position.

Example 3 includes the apparatus of example 1, wherein the display back is flush with the inner housing, the housing further including a recess located in the inner housing, the recess to enclose at least a portion of the piezoelectric microphone.

Example 4 includes the apparatus of example 1, further including a gap between the inner housing and the display back, wherein the housing further includes a recess located in the inner housing, the recess to receive the piezoelectric microphone.

Example 5 includes the apparatus of example 1, wherein the piezoelectric microphone is located in a gap between the inner housing and the display back, the piezoelectric microphone directly coupled to the inner housing.

Example 6 includes the apparatus of example 1, wherein the piezoelectric microphone is located in a gap between the inner housing and the display back, the piezoelectric microphone directly coupled to the display back.

Example 7 includes the apparatus of example 1, further including a bezel cover coupled to the display and the housing, the bezel cover to protect components within the bezel area.

Example 8 includes the apparatus of example 1, wherein the housing includes more than one piezoelectric microphone located between the housing and the display back, the piezoelectric microphones located beneath holes.

Example 9 includes a system for identifying target audio from a computing device, the system comprising a housing including an inner housing, an outer housing, and one or more holes, a display, the display including a display front and a display back, a piezoelectric microphone between the housing and the display back, the piezoelectric microphone to detect audio, a digital microphone to detect audio, and an audio analyzer to identify target audio, the target audio accessed via one or more of the piezoelectric microphone or the digital microphone, analyze differences in time of receipt of the target audio, the difference in time of receipt based on a distance between the piezoelectric microphones and the digital microphone, and isolate target audio from ambient audio.

Example 10 includes the system of example 9, wherein the piezoelectric microphone is to produce a voltage corresponding to the target audio.

Example 11 includes the system of example 9, wherein the digital microphone is to convert the target audio into a digital signal.

Example 12 includes the system of example 11, wherein the digital signal is a first digital signal, the audio analyzer is to convert a voltage into a second digital signal, the second digital signal to be compared with the first digital signal.

Example 13 includes the system of example 9, wherein the audio analyzer is to isolate the target audio by removing the ambient audio coming from the opposite direction of the target audio.

Example 14 includes a computing device comprising, a housing including a first edge, a second edge, a third edge, and a fourth edge, the first edge parallel to and opposite the second edge, the third edge parallel to and opposite the fourth edge, a first DMIC hole located a first distance from the third edge and a second distance from the first edge, a second DMIC hole located a third distance from the fourth edge and a fourth distance from the first edge, and a piezo hole located a fifth distance from the fourth edge and a sixth distance from the second edge, a piezoelectric microphone positioned along a first axis of the piezo hole, the piezoelectric microphone located between the housing and a display back, a first DMIC microphone positioned along a second axis of the first DMIC hole, the first DMIC microphone located between the housing and a bezel cover, and a second DMIC microphone positioned along a third axis of the second DMIC hole, the second DMIC microphone located between the housing and the bezel cover.

Example 15 includes the computing device of example 14, wherein the second distance and the fourth distance are equal.

Example 16 includes the computing device of example 14, wherein a sum of the first distance and the third distance is less than the length of the first edge.

Example 17 includes the computing device of example 14, further including a bezel area located near the first edge, the bezel area to at least partially surround the DMIC microphones.

Example 18 includes the computing device of example 14, wherein the piezo hole, the first DMIC hole, and the second DMIC hole are noncollinear.

Example 19 includes the computing device of example 14, wherein the sixth distance is greater than zero and does not locate the piezo hole above a bezel area.

Example 20 includes the computing device of example 14, wherein the sixth distance is greater than the second distance and the fourth distance.

Example 21 includes the computing device of example 14, wherein the first distance, the third distance, and the fifth distance are measured parallel to a longitude line and the second distance, the fourth distance, and the sixth distance are measured parallel to a latitude line.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

The following claims are hereby incorporated into this Detailed Description by this reference, with each claim standing on its own as a separate embodiment of the present disclosure.

What is claimed is:

1. An apparatus for identifying target audio from a computing device, the apparatus comprising:
a housing including an inner housing, an outer housing, and one or more holes;
a bezel area, wherein the bezel area includes one or more microphones;
a display, the display including a display front and a display back;
a piezoelectric microphone located between the housing and the display back, the piezoelectric microphone located beneath one of the holes, wherein the piezoelectric microphone is to detect audio; and
an audio analyzer to analyze the audio retrieved from the piezoelectric microphone.

2. The apparatus of claim 1, wherein the computing device is a laptop, the laptop to identify target audio while in a closed position.

3. The apparatus of claim 1, wherein the display back is flush with the inner housing, the housing further including a recess located in the inner housing, the recess to enclose at least a portion of the piezoelectric microphone.

4. The apparatus of claim 1, further including a gap between the inner housing and the display back, wherein the housing further includes a recess located in the inner housing, the recess to receive the piezoelectric microphone.

5. The apparatus of claim 1, wherein the piezoelectric microphone is located in a gap between the inner housing and the display back, the piezoelectric microphone directly coupled to the inner housing.

6. The apparatus of claim 1, wherein the piezoelectric microphone is located in a gap between the inner housing and the display back, the piezoelectric microphone directly coupled to the display back.

7. The apparatus of claim 1, further including a bezel cover coupled to the display and the housing, the bezel cover to protect components within the bezel area.

8. The apparatus of claim 1, wherein the housing includes more than one piezoelectric microphone located between the housing and the display back, the piezoelectric microphones located beneath holes.

9. A system for identifying target audio from a computing device, the system comprising:
a housing including an inner housing, an outer housing, and one or more holes;
a display, the display including a display front and a display back;
a piezoelectric microphone between the housing and the display back, the piezoelectric microphone to detect audio;
a digital microphone to detect audio; and
an audio analyzer to:
identify target audio, the target audio accessed via one or more of the piezoelectric microphone or the digital microphone;
analyze differences in time of receipt of the target audio, the difference in time of receipt based on a distance between the piezoelectric microphones and the digital microphone; and
isolate target audio from ambient audio.

10. The system of claim 9, wherein the piezoelectric microphone is to produce a voltage corresponding to the target audio.

11. The system of claim 9, wherein the digital microphone is to convert the target audio into a digital signal.

12. The system of claim 11, wherein the digital signal is a first digital signal, the audio analyzer is to convert a voltage into a second digital signal, the second digital signal to be compared with the first digital signal.

13. The system of claim 9, wherein the audio analyzer is to isolate the target audio by removing the ambient audio coming from the opposite direction of the target audio.

14. A computing device comprising;
a housing including:
a first edge, a second edge, a third edge, and a fourth edge, the first edge parallel to and opposite the second edge, the third edge parallel to and opposite the fourth edge;
a first DMIC hole located a first distance from the third edge and a second distance from the first edge;
a second DMIC hole located a third distance from the fourth edge and a fourth distance from the first edge; and
a piezo hole located a fifth distance from the fourth edge and a sixth distance from the second edge;
a piezoelectric microphone positioned along a first axis of the piezo hole, the piezoelectric microphone located between the housing and a display back;
a first DMIC microphone positioned along a second axis of the first DMIC hole, the first DMIC microphone located between the housing and a bezel cover; and
a second DMIC microphone positioned along a third axis of the second DMIC hole, the second DMIC microphone located between the housing and the bezel cover.

15. The computing device of claim 14, wherein the second distance and the fourth distance are equal.

16. The computing device of claim 14, wherein a sum of the first distance and the third distance is less than the length of the first edge.

17. The computing device of claim 14, further including a bezel area located near the first edge, the bezel area to at least partially surround the DMIC microphones.

18. The computing device of claim 14, wherein the piezo hole, the first DMIC hole, and the second DMIC hole are noncollinear.

19. The computing device of claim 14, wherein the sixth distance is greater than zero and does not locate the piezo hole above a bezel area.

20. The computing device of claim 14, wherein the sixth distance is greater than the second distance and the fourth distance.

21. The computing device of claim 14, wherein the first distance, the third distance, and the fifth distance are measured parallel to a longitude line and the second distance, the fourth distance, and the sixth distance are measured parallel to a latitude line.
